(19) United States
(12) Patent Application Publication
(10) Pub. No.: US 2026/0194403 A1
(43) Pub. Date: Jul. 9, 2026

(54) PROBE COVER DELIVERY DEVICE

(71) Applicant: RADIANT INNOVATION INC., Hsinchu County (TW)

(72) Inventors: TSENG-LUNG LIN, Hsinchu County (TW); I-LING CHEN, Hsinchu County (TW)

(21) Appl. No.: 19/008,650

(22) Filed: Jan. 3, 2025

(51) Int. Cl. G01K 13/25

(52) U.S. Cl. CPC G01K 13/25

(57) ABSTRACT

A probe cover delivery device includes a probe cover delivery base, a probe cover pushing assembly and a probe cover accommodating accessory. The probe cover pushing assembly is disposed on the probe cover delivery base, and the probe cover accommodating accessory is disposed on the probe cover delivery base. The probe cover pushing assembly includes a first probe cover pushing element and a second probe cover pushing element, the first probe cover pushing element has a first supporting portion and a first pushing portion disposed on the first supporting portion. The second probe cover pushing element has a second supporting portion and a second pushing portion disposed on the first supporting portion. The ear thermometer probe cover can be pushed by the first pushing portion and the second pushing portion to fall from the probe cover accommodating portion to the base body of the probe cover delivery base.

### FIELD OF THE DISCLOSURE

The present disclosure relates to a probe cover delivery device, and more particularly to a probe cover delivery device applied to an ear thermometer probe of an ear thermometer.

### BACKGROUND OF THE DISCLOSURE

Currently, most ear thermometers on the market need to be used with special probe covers. The ear thermometer can obtain a correct temperature measurement result through the special probe cover. On the other hand, for hygiene reasons, using the special probe cover can avoid the increased risk of infection caused by different people using the ear thermometer. However, in the related art, a method of providing probe covers to the ear thermometer still has room for improvement.

### SUMMARY OF THE DISCLOSURE

In response to the above-referenced technical inadequacy, the present disclosure provides a probe cover delivery device which can use a first pushing portion and a second pushing portion of a probe cover pushing assembly to push a bottommost one of a plurality of ear thermometer probe covers, so that the bottommost ear thermometer probe cover can fall from a probe cover accommodating portion of a probe cover accommodating accessory to a base body of a probe cover delivery base.

In order to solve the above-mentioned problems, one of the technical aspects adopted by the present disclosure is to provide a probe cover delivery device, which includes a probe cover delivery base, a probe cover pushing assembly and a probe cover accommodating accessory. The probe cover delivery base has a base body, a first sliding groove structure disposed on the base body, and a second sliding groove structure disposed on the base body. The probe cover pushing assembly is disposed on the base body. The probe cover accommodating accessory is disposed on the base body. The probe cover pushing assembly includes a first probe cover pushing element and a second probe cover pushing element corresponding to the first probe cover pushing element, the first probe cover pushing element has a first supporting portion disposed on the base body and a first pushing portion disposed on the first supporting portion, and the second probe cover pushing element has a second supporting portion disposed on the base body and a second pushing portion disposed on the first supporting portion. The probe cover accommodating accessory includes a probe cover accommodating portion for accommodating a plurality of ear thermometer probe covers, a first cooperating portion connected to the probe cover accommodating portion and movably cooperating with the first sliding groove structure, and a second cooperating portion connected to the probe cover accommodating portion and movably cooperating with the second sliding groove structure.

In order to solve the above-mentioned problems, another one of the technical aspects adopted by the present disclosure is to provide a probe cover delivery device, which includes a probe cover delivery base, a probe cover pushing assembly and a probe cover accommodating accessory. The probe cover delivery base has a base body, the probe cover pushing assembly is disposed on the base body, and the probe cover accommodating accessory is disposed on the base body. The probe cover pushing assembly includes a first probe cover pushing element and a second probe cover pushing element corresponding to the first probe cover pushing element, the first probe cover pushing element has a first supporting portion disposed on the base body and a first pushing portion disposed on the first supporting portion, and the second probe cover pushing element has a second supporting portion disposed on the base body and a second pushing portion disposed on the first supporting portion. The probe cover accommodating accessory includes a probe cover accommodating portion for accommodating a plurality of ear thermometer probe covers, a first cooperating portion connected to the probe cover accommodating portion, and a second cooperating portion connected to the probe cover accommodating portion.

In order to solve the above-mentioned problems, yet another one of the technical aspects adopted by the present disclosure is to provide a probe cover delivery device, which includes a probe cover delivery base, a probe cover pushing assembly and a probe cover accommodating accessory. The probe cover pushing assembly is disposed on the probe cover delivery base, and the probe cover accommodating accessory is disposed on the probe cover delivery base. The probe cover pushing assembly includes a first probe cover pushing element and a second probe cover pushing element, the first probe cover pushing element has a first supporting portion and a first pushing portion disposed on the first supporting portion, and the second probe cover pushing element has a second supporting portion and a second pushing portion disposed on the first supporting portion.

Hence, when a bottommost one of the plurality of ear thermometer probe covers is pushed by the first pushing portion and the second pushing portion of the probe cover pushing assembly to fall from the probe cover accommodating portion of the probe cover accommodating accessory to the base body of the probe cover delivery base, the probe cover accommodating space of the base body of the probe cover delivery base is configured for accommodating a probe cover portion of the fallen ear thermometer probe cover, and the first probe cover delivery platform and the second probe cover delivery platform of the base body of the probe cover delivery base are configured to respectively carry two opposite side portions of the fallen ear thermometer probe cover. In addition, when the first probe cover delivery platform and the second probe cover delivery platform of the base body of the probe cover delivery base are configured to respectively carry the two opposite side portions of the fallen ear thermometer probe cover, the fallen ear thermometer probe cover is pushed by the probe cover accommodating accessory to move from the first probe cover delivery platform and the second probe cover delivery platform to the probe cover limiting platform.

Therefore, in the probe cover delivery device provided by the present disclosure, by virtue of “the probe cover pushing assembly including a first probe cover pushing element and a second probe cover pushing element,” when the bottommost ear thermometer probe cover is pushed by the first pushing portion and the second pushing portion of the probe cover pushing assembly, the bottommost ear thermometer probe cover can fall from the probe cover accommodating portion of the probe cover accommodating accessory to the base body of the probe cover delivery base.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective exploded view of a probe cover delivery device provided by the present disclosure;

FIG. 2 is another schematic perspective exploded view of the probe cover delivery device provided by the present disclosure;

FIG. 3 is a schematic side view of the probe cover delivery device provided by the present disclosure;

FIG. 4 is a schematic perspective assembled view of the probe cover delivery device provided by the present disclosure;

FIG. 5 is a schematic perspective view of the first operating action of the probe cover delivery device provided by the present disclosure (a user provides a predetermined force to a probe cover accommodating accessory, so that the probe cover accommodating accessory can move forward to a first predetermined position relative to a probe cover pushing assembly);

FIG. 6 is a schematic perspective view of the second operating action of the probe cover delivery device provided by the present disclosure (the probe cover accommodating accessory returns to an original position from the first predetermined position through the cooperation of a first elastic element and a second elastic element);

FIG. 7 is a schematic view of an ear thermometer probe cover of the probe cover delivery device provided by the present disclosure (before pushing the ear thermometer probe cover through a first pushing portion and a second pushing portion of the probe cover pushing assembly);

FIG. 8 is a schematic view of the ear thermometer probe cover of the probe cover delivery device provided by the present disclosure (after pushing the ear thermometer probe cover through the first pushing portion and second pushing portion of the probe cover pushing assembly);

FIG. 9 is a perspective schematic view of the third operating action of the probe cover delivery device provided by the present disclosure (the ear thermometer probe cover is pushed by the probe cover accommodating accessory to move from the first probe cover delivery platform and the second probe cover delivery platform to the probe cover limiting platform, or the user provides a predetermined force to the probe cover accommodating accessory, so that the probe cover accommodating accessory can move forward to a second predetermined position relative to the probe cover pushing assembly);

FIG. 10 is a perspective view of the fourth operating action of the probe cover delivery device provided by the present disclosure (the probe cover accommodating accessory returns to the original position from the second predetermined position through the cooperation of the first elastic element and the second elastic element); and

FIG. 11 is a schematic view of the ear thermometer probe cover of the probe cover delivery device provided by the present disclosure being placed on an ear thermometer probe of an ear thermometer.

### DETAILED DESCRIPTION OF THE EXEMPLARY EMBODIMENTS

The present disclosure is more particularly described in the following embodiments and examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” may include plural reference, and the meaning of “in” may include “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

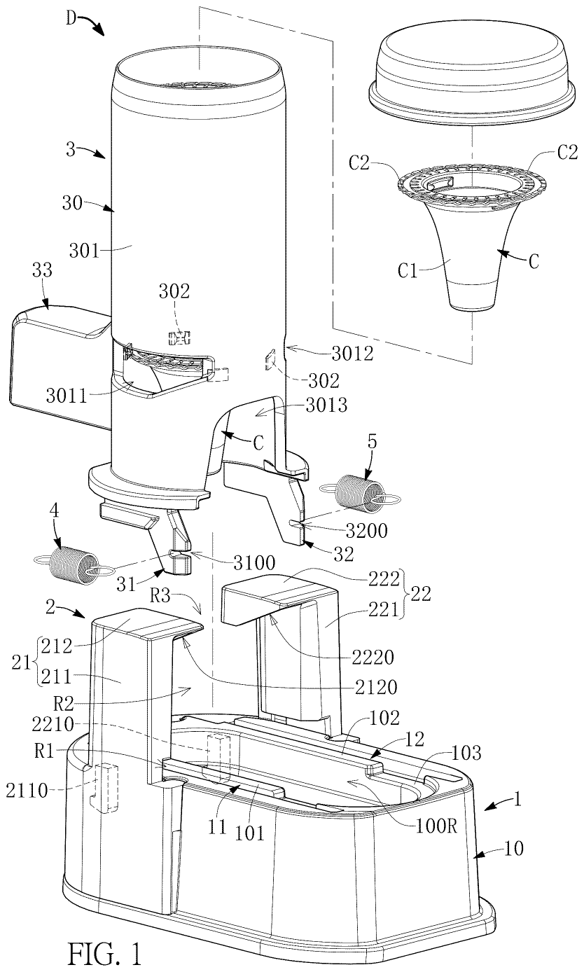

Referring to FIG. 1 to FIG. 11, the present disclosure provides a probe cover delivery device D (or an integrated probe cover dispenser or a detachable probe cover dispenser), which may at least include a probe cover delivery base 1 (or a probe cover dispensing base), a probe cover pushing assembly 2 (or a probe cover abutting assembly) and a probe cover accommodating accessory 3 (or a probe cover receiving structure, or a probe cover storage fitting). More particularly, the probe cover pushing assembly 2 can be detachably or fixedly disposed on the probe cover delivery base 1, and the probe cover accommodating accessory 3 can be detachably or movably disposed on the probe cover delivery base 1. In addition, the probe cover pushing assembly 2 may include a first probe cover pushing element 21 (or a first probe cover abutting piece) and a second probe cover pushing element 22 (or a second probe cover abutting piece), the first probe cover pushing element 21 may have a first supporting portion 211 (or a first holding portion) and a first pushing portion 212 disposed on the first supporting portion 211, and the second probe cover pushing element 22 may have a second supporting portion 221 (or a second holding portion) and a second pushing portion 222 disposed on the first supporting portion 211.

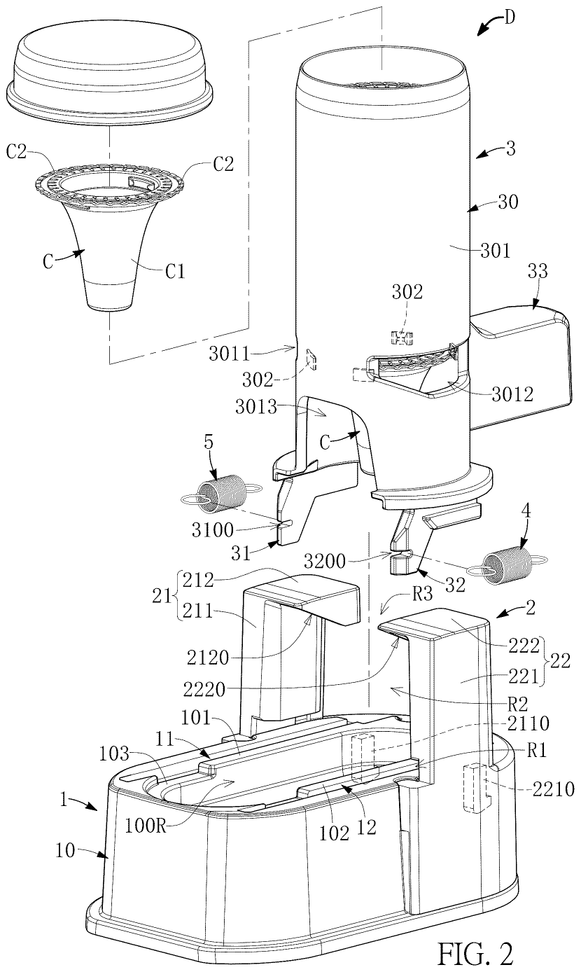

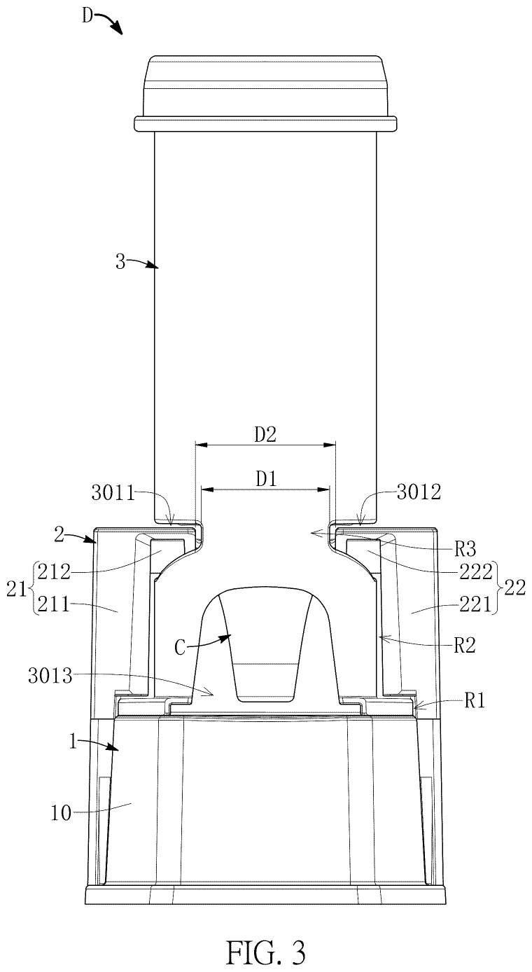

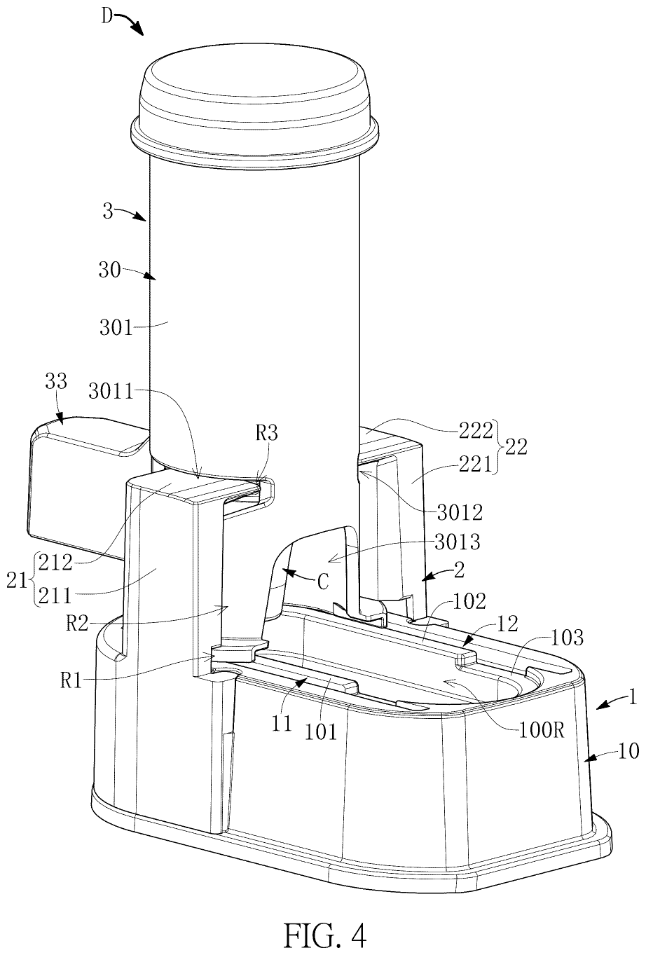

For example, referring to FIG. 1, FIG. 2, FIG. 3 and FIG. 4, the probe cover delivery base 1 may have a base body 10, a first sliding groove structure 11 (or a first groove structure) that can be disposed on the base body 10, and a second sliding groove structure 12 (or a second groove structure) that can be disposed on the base body 10. More particularly, the base body 10 of the probe cover delivery base 1 may have a probe cover accommodating space 100R located between the first sliding groove structure 11 and the second sliding groove structure 12, and the probe cover accommodating space 100R can pass through the base body 10 (alternatively, the probe cover accommodating space 100R may not penetrate the base body 10 and present a half closed groove space). In addition, the base body 10 of the probe cover delivery base 1 may have a first probe cover delivery platform 101 (or a first probe cover sliding plane), a second probe cover delivery platform 102 (or a second probe cover sliding plane) corresponding to the first probe cover delivery platform 101, and a probe cover limiting platform 103 (or a probe cover standby platform having an accommodating space) connected to the first probe cover delivery platform 101 and the second probe cover delivery platform 102. It should be noted that the first probe cover delivery platform 101 and the second probe cover delivery platform 102 may have the same height, and a height of the probe cover limiting platform 103 can be lower than a height of the first probe cover delivery platform 101 and a height of the second probe cover delivery platform 102. However, the aforementioned details are disclosed for exemplary purposes only, and are not meant to limit the scope of the present disclosure.

For example, referring to FIG. 1, FIG. 2, FIG. 3 and FIG. 4, the probe cover pushing assembly 2 can be detachably or fixedly disposed on the base body 10, and the probe cover pushing assembly 2 may include a first probe cover pushing element 21 and a second probe cover pushing element 22 corresponding to the first probe cover pushing element 21. In addition, the first probe cover pushing element 21 may have a first supporting portion 211 disposed on the base body 10 and a first pushing portion 212 disposed on the first supporting portion 211, and the second probe cover pushing element 22 may have a second supporting portion 221 disposed on the base body 10 and a second pushing portion 222 disposed on the first supporting portion 211. More particularly, the first probe cover pushing element 21 and the second probe cover pushing element 22 of the probe cover pushing assembly 2 can be detachably or fixedly disposed on the base body 10 of the probe cover delivery base 1, and the first probe cover pushing element 21 and the second probe cover pushing element 22 can be two independent components or are combined into a single component according to different requirements. Moreover, the first pushing portion 212 of the first probe cover pushing element 21 may have a first inclined surface 2120 showing a first predetermined inclination angle (such as any positive integer between 20 degrees and 70 degrees), the second pushing portion 222 of the second probe cover pushing element 22 may have a second inclined surface 2220 showing a second predetermined inclination angle (such as any positive integer between 20 degrees and 70 degrees), and the first inclined surface 2120 of the first pushing portion 212 and the second inclined surface 2220 of the second pushing portion 222 can be configured to respectively contact two opposite side portions C2 of the same ear thermometer probe cover C (or a replaceable probe cover, especially a hard replaceable probe cover). It should be noted that a first accommodation space R1 (or a lower accommodation space) and a second accommodation space R2 (or an upper accommodation space) can be formed between the first supporting portion 211 of the first probe cover pushing element 21 and the second supporting portion 221 of the second probe cover pushing element 22, the first accommodation space R1 and the second accommodation space R2 can be communicated with each other, and a width (or maximum width) of the second accommodation space R2 can be smaller than a width (or maximum width) of the first accommodation space R1. In addition, a third accommodation space R3 can be formed between the first pushing portion 212 of the first probe cover pushing element 21 and the second pushing portion 222 of the second probe cover pushing element 22, the third accommodation space R3 can be communicated with the second accommodation space R2, and a width (or maximum width) of the third accommodation space R3 can be smaller than the width (or maximum width) of the second accommodation space R2. Therefore, the probe cover pushing assembly 2 can provide enough space for accommodating the probe cover accommodating accessory 3, thereby preventing the probe cover pushing assembly 2 and the probe cover accommodating accessory 3 from interfering with each other. However, the aforementioned details are disclosed for exemplary purposes only, and are not meant to limit the scope of the present disclosure.

For example, referring to FIG. 1, FIG. 2, FIG. 3 and FIG. 4, the probe cover accommodating accessory 3 can be detachably or movably disposed on the base body 10, and the probe cover accommodating accessory 3 may include a probe cover accommodating portion 30 (or a probe cover containing tube), a first cooperating portion 31 (or a first sliding structure) and a second cooperating portion 32 (or a second sliding structure). In addition, the probe cover accommodating portion 30 can be configured for accommodating a plurality of ear thermometer probe covers C, the first cooperating portion 31 can be connected to the probe cover accommodating portion 30 and movably cooperate with the first sliding groove structure 11, and the second cooperating portion 32 can be connected to the probe cover accommodating portion 30 and movably cooperate with the second sliding groove structure 12. More particularly, the probe cover accommodating portion 30 of the probe cover accommodating accessory 3 may have a hollow body 301 (or a hollow tube body) and a plurality of probe cover limiting bodies 302 (or multiple protruding microstructures) that can be disposed on an inner surface of the hollow body 301, so that when the plurality of ear thermometer probe covers C are stacked on top of one another in sequence and accommodated in the hollow body 301 of the probe cover accommodating portion 30, the plurality of probe cover limiting bodies 302 can be configured to contact a bottommost one of the plurality of ear thermometer probe covers C (or to simultaneously support multiple ear thermometer probe covers C accommodated in the hollow body 301 of the probe cover accommodating portion 30). In addition, the hollow body 301 of the probe cover accommodating portion 30 may have a first opening 3011 corresponding to the first pushing portion 212, and a second opening 3012 corresponding to the second pushing portion 222, and a shortest distance D1 between the first opening 3011 and the second opening 3012 of the hollow body 301 can be smaller than a shortest distance D2 between the first pushing portion 212 and the second pushing portion 222 of the probe cover pushing assembly 2, thereby avoiding interference between the probe cover accommodating accessory 3 (specifically refers to the probe cover accommodating portion 30) and the probe cover pushing assembly 2 (specifically refers to the first probe cover pushing element 21 and the second probe cover pushing element 22). It should be noted that the probe cover accommodating portion 30 of the probe cover accommodating accessory 3 may have a hand-pressed protruding rod portion 33 (or a pressing contacting portion) connected to an outer surface of the hollow body 301, and the hollow body 301 of the probe cover accommodating portion 30 may have a probe cover viewing window 3013 (or a probe cover inspection area, which can be used to facilitate the user to view the ear thermometer probe cover C, and help the user to remove the ear thermometer probe cover C that is stuck and cannot move) facing away from the hand-pressed protruding rod portion 33. In addition, in one of the feasible embodiments, a vertical distance (or shortest distance) between the probe cover limiting body 302 and the first probe cover delivery platform 101 needs to be greater than the height or length of the ear thermometer probe cover C (for example, the vertical distance between the probe cover limiting body 302 and the first probe cover delivery platform 101 needs to be greater than or equal to 1.1 times the height or length of the ear thermometer probe cover C). However, the aforementioned details are disclosed for exemplary purposes only, and are not meant to limit the scope of the present disclosure.

It should be noted that, for example, referring to FIG. 1 and FIG. 2, the first supporting portion 211 of the first probe cover pushing element 21 may have a first fixed hook body 2110, the first cooperating portion 31 of the probe cover accommodating accessory 3 may have a first movable hook body 3100, and a first elastic element 4 (such as a first tension spring) provided by the present disclosure can be disposed and connected between the first fixed hook body 2110 of the first supporting portion 211 and the first movable hook body 3100 of the probe cover accommodating accessory 3, thereby adjusting or restricting the position of the first cooperating portion 31 of the probe cover accommodating accessory 3 relative to the first supporting portion 211 of the first probe cover pushing element 21 (in particular, the first elastic element 4 can be configured to provide an elastic force to the first cooperating portion 31 of the probe cover accommodating accessory 3 to cause reset movement). In addition, wherein the second supporting portion 221 of the second probe cover pushing element 22 may have a second fixed hook body 2210, the second cooperating portion 32 of the probe cover accommodating accessory 3 may have a second movable hook body 3200, and a second elastic element 5 (such as a second tension spring) provided by the present disclosure can be disposed and connected between the second fixed hook body 2210 of the second supporting portion 221 and the second movable hook body 3200 of the probe cover accommodating accessory 3, thereby adjusting and restricting the position of the second cooperating portion 32 of the probe cover accommodating accessory 3 relative to the second supporting portion 221 of the second probe cover pushing element 22 (in particular, the second elastic element 5 can be configured to provide an elastic force to the second cooperating portion 32 of the probe cover accommodating accessory 3 to cause reset movement). That is to say, when the force applied to the probe cover accommodating accessory 3 is released, the first elastic element 4 and the second elastic element 5 may cooperate with each other to provide an elastic force to the probe cover accommodating accessory 3 to cause reset movement (that is to say, the probe cover accommodating accessory 3 can be pulled back to its original position through the cooperation of the first elastic element 4 and the second elastic element 5). It is worth noting that in one possible embodiment, the first elastic element 4 and the second elastic element 5 can also be integrated into only one elastic element. Therefore, according to different requirements, the probe cover delivery device D provided by the present disclosure can use two or more elastic elements (such as using the first elastic element 4 and the second elastic element 5), or just use an elastic element only. However, the aforementioned details are disclosed for exemplary purposes only, and are not meant to limit the scope of the present disclosure.

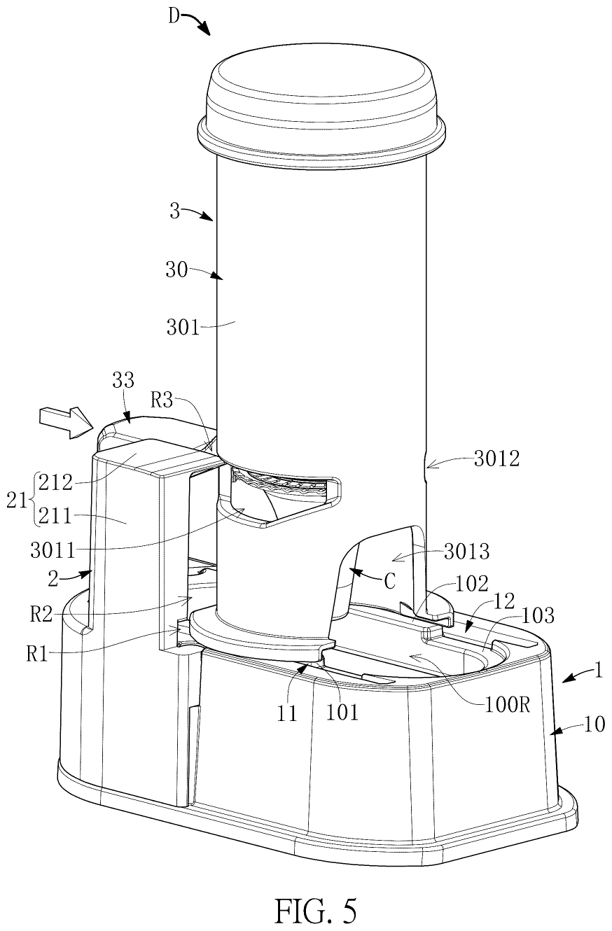

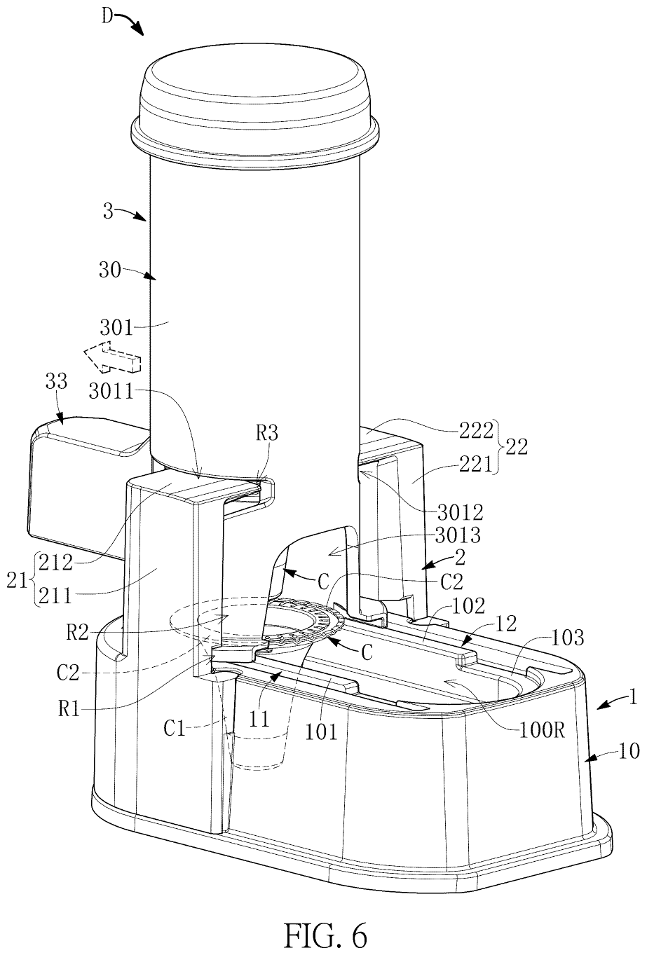

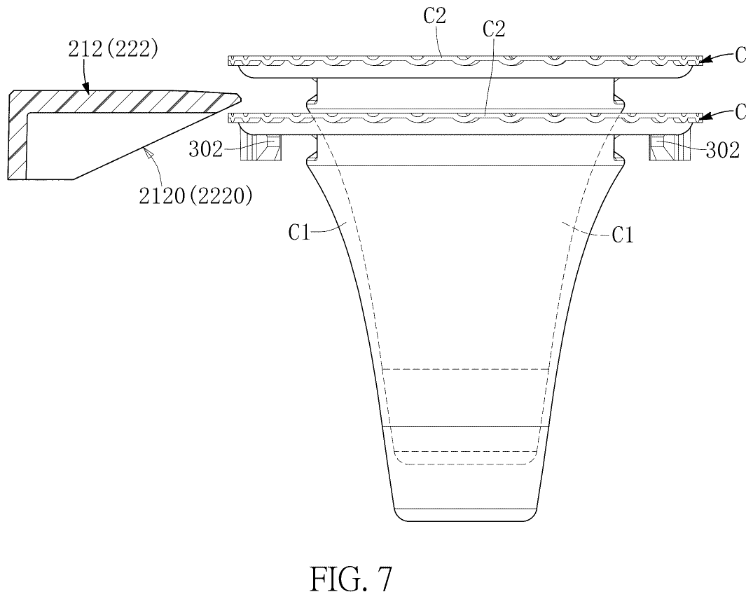

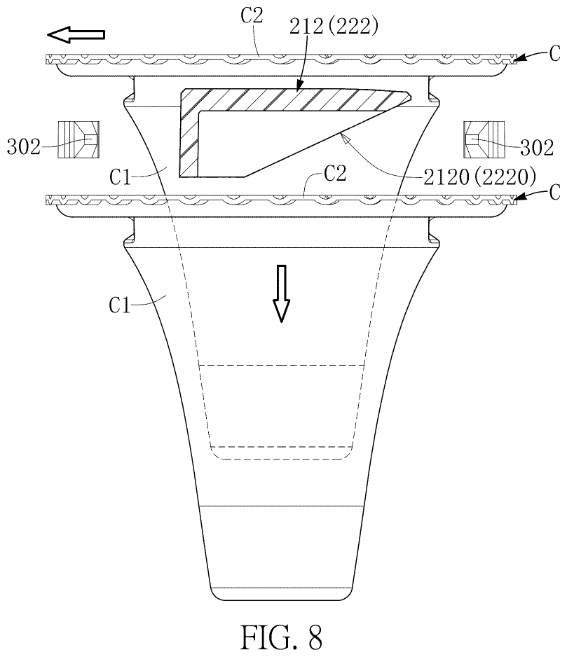

Therefore, for example, referring to FIG. 4 and FIG. 5, the user can apply a predetermined force to the probe cover accommodating accessory 3 (such as exerting a predetermined pushing force on the hand-pressed protruding rod portion 33), so that the probe cover accommodating accessory 3 can move forward to a predetermined position relative to the probe cover pushing assembly 2 (as shown in FIG. 5, for example, the predetermined position may be a predetermined position where the probe cover accommodating accessory 3 is completely separated from the probe cover pushing assembly 2, or the predetermined position may be a first predetermined position where the first opening 3011 and the second opening 3012 of the hollow body 301 are respectively separated from the first pushing portion 212 and the second pushing portion 222). Furthermore, as shown in FIG. 5 and FIG. 6, when the predetermined force (such as the predetermined pushing force) applied to the probe cover accommodating accessory 3 is released, the first elastic element 4 and the second elastic element 5 can cooperate with each other to provide an elastic force to the probe cover accommodating accessory 3 to cause reset movement, thereby allowing the probe cover accommodating accessory 3 to return to the original position from the first predetermined position (as shown in FIG. 6, the original position is the position where the probe cover delivery device D is not exerted by any external force). Moreover, referring to FIG. 6, FIG. 7 and FIG. 8, when the probe cover accommodating accessory 3 returns to the original position from the first predetermined position (as shown in FIG. 6), the ear thermometer probe cover C (i.e., the bottommost one of the ear thermometer probe covers C) can be pushed (or abutted) by the first pushing portion 212 and the second pushing portion 222 of the probe cover pushing component 2, and then fall on the base body 10 of the probe cover delivery base 1 from the probe cover accommodating portion 30 of the probe cover accommodating accessory 3 (as shown in FIG. 6 and FIG. 8). However, the aforementioned details are disclosed for exemplary purposes only, and are not meant to limit the scope of the present disclosure.

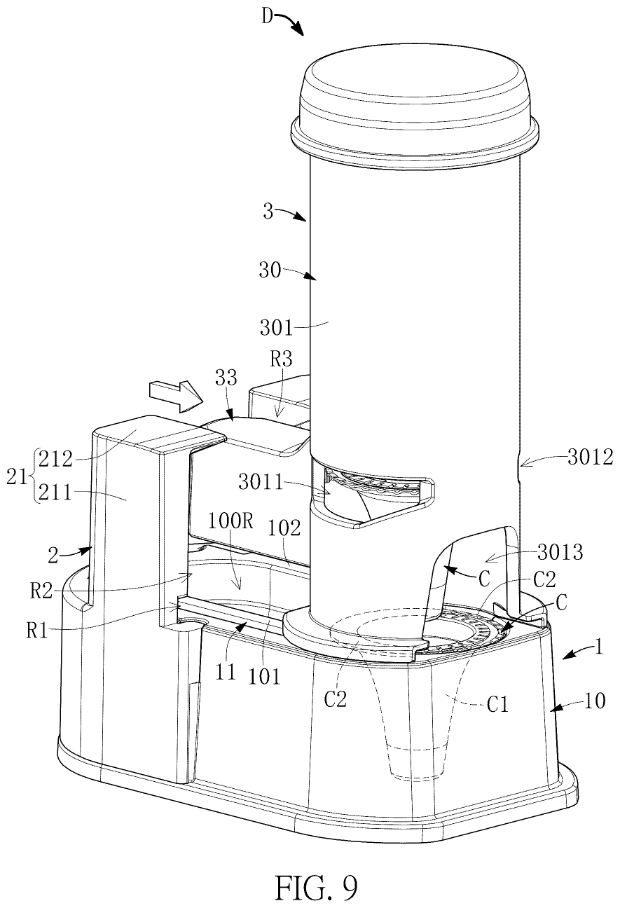

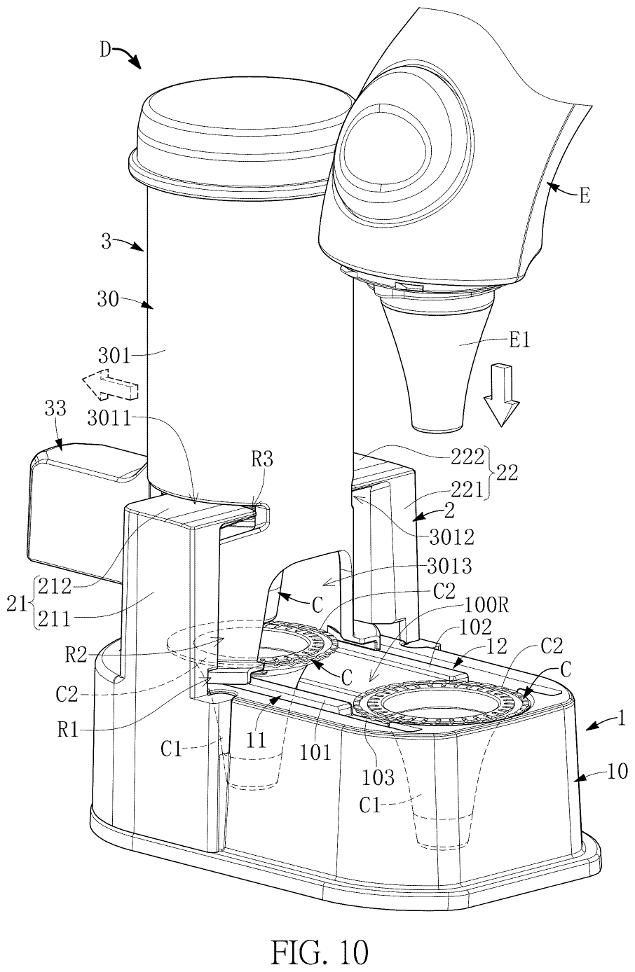

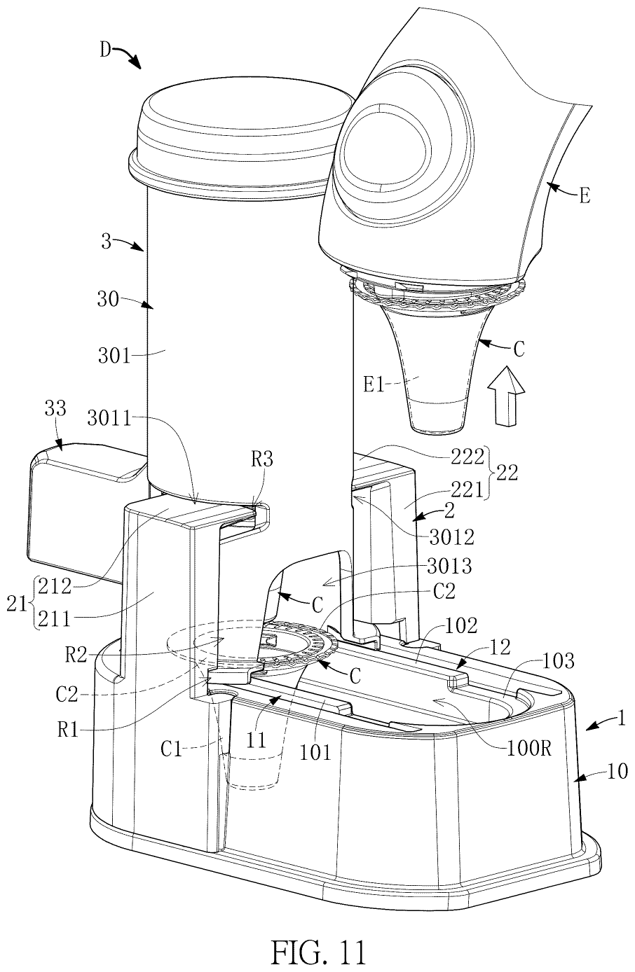

Based on the above, more particularly, referring to FIG. 6 and FIG. 8, when a bottommost one of the plurality of ear thermometer probe covers C is pushed by the first pushing portion 212 and the second pushing portion 222 of the probe cover pushing assembly 2 to fall or drop from the probe cover accommodating portion 30 of the probe cover accommodating accessory 3 to the base body 10 of the probe cover delivery base 1, the probe cover accommodating space 100R of the base body 10 of the probe cover delivery base 1 can be configured for accommodating a probe cover portion C1 of the fallen ear thermometer probe cover C, and the first probe cover delivery platform 101 and the second probe cover delivery platform 102 of the base body 10 of the probe cover delivery base 1 can be configured to respectively carry or hold two opposite side portions C2 of the fallen ear thermometer probe cover C that is fell or dropped from the probe cover accommodating portion 30 of the probe cover accommodating accessory 3. Furthermore, referring to FIG. 6 and FIG. 9, when the first probe cover delivery platform 101 and the second probe cover delivery platform 102 of the base body 10 of the probe cover delivery base 1 are configured to respectively carry the two opposite side portions C2 of the fallen ear thermometer probe cover C (as shown in FIG. 6), the fallen ear thermometer probe cover C can be pushed by the probe cover accommodating accessory 3 to move from the first probe cover delivery platform 101 and the second probe cover delivery platform 102 to the probe cover limiting platform 103 (that is to say, the probe cover accommodating accessory 3 can be moved from the original position to the second predetermined position, as shown in FIG. 9). Moreover, referring to FIG. 9, FIG. 10 and FIG. 11, when the predetermined force (such as the predetermined pushing force) applied to the probe cover accommodating accessory 3 is released and the probe cover accommodating accessory 3 returns to the original position from the second predetermined position through the cooperation of the first elastic element 4 and the second elastic element 5 (as shown in FIG. 10), an ear thermometer E can insert its ear thermometer probe E1 into the ear thermometer probe cover C that is disposed on the probe cover limiting platform 103, thereby placing or setting the ear thermometer probe cover C on the ear thermometer probe E1 of the ear thermometer E, so that the user can use the ear thermometer E to measure his or her ear temperature. However, the aforementioned details are disclosed for exemplary purposes only, and are not meant to limit the scope of the present disclosure.

### Beneficial Effects of the Embodiments

In conclusion, in the probe cover delivery device D provided by the present disclosure, by virtue of “the probe cover pushing assembly 2 including a first probe cover pushing element 21 and a second probe cover pushing element 22,” when the bottommost ear thermometer probe cover is pushed by the first pushing portion 212 and the second pushing portion 222 of the probe cover pushing assembly 2, the bottommost ear thermometer probe cover can fall from the probe cover accommodating portion 30 of the probe cover accommodating accessory 3 to the base body 10 of the probe cover delivery base 1.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A probe cover delivery device, comprising:
a probe cover delivery base having a base body, a first sliding groove structure disposed on the base body, and a second sliding groove structure disposed on the base body;
a probe cover pushing assembly disposed on the base body; and
a probe cover accommodating accessory disposed on the base body;
wherein the probe cover pushing assembly includes a first probe cover pushing element and a second probe cover pushing element corresponding to the first probe cover pushing element, the first probe cover pushing element has a first supporting portion disposed on the base body and a first pushing portion disposed on the first supporting portion, and the second probe cover pushing element has a second supporting portion disposed on the base body and a second pushing portion disposed on the first supporting portion; and
wherein the probe cover accommodating accessory includes a probe cover accommodating portion for accommodating a plurality of ear thermometer probe covers, a first cooperating portion connected to the probe cover accommodating portion and movably cooperating with the first sliding groove structure, and a second cooperating portion connected to the probe cover accommodating portion and movably cooperating with the second sliding groove structure.

2. The probe cover delivery device according to claim 1,
wherein the base body of the probe cover delivery base has a probe cover accommodating space located between the first sliding groove structure and the second sliding groove structure, and the probe cover accommodating space passes through the base body;
wherein the base body of the probe cover delivery base has a first probe cover delivery platform, a second probe cover delivery platform corresponding to the first probe cover delivery platform, and a probe cover limiting platform connected to the first probe cover delivery platform and the second probe cover delivery platform, and a height of the probe cover limiting platform is lower than a height of the first probe cover delivery platform and a height of the second probe cover delivery platform;
wherein the first probe cover pushing element and the second probe cover pushing element of the probe cover pushing assembly are detachably disposed on the base body of the probe cover delivery base, and the first probe cover pushing element and the second probe cover pushing element are two independent components or are combined into a single component;
wherein the first pushing portion of the first probe cover pushing element has a first inclined surface, the second pushing portion of the second probe cover pushing element has a second inclined surface, and the first inclined surface of the first pushing portion and the second inclined surface of the second pushing portion are configured to respectively contact two opposite side portions of one of the plurality of ear thermometer probe covers;
wherein a first accommodation space and a second accommodation space are formed between the first supporting portion of the first probe cover pushing element and the second supporting portion of the second probe cover pushing element, the first accommodation space and the second accommodation space are communicated with each other, and a width of the second accommodation space is smaller than a width of the first accommodation space; and
wherein a third accommodation space is formed between the first pushing portion of the first probe cover pushing element and the second pushing portion of the second probe cover pushing element, the third accommodation space is communicated with the second accommodation space, and a width of the third accommodation space is smaller than the width of the second accommodation space.

3. The probe cover delivery device according to claim 1,
wherein the probe cover accommodating portion of the probe cover accommodating accessory has a hollow body and a plurality of probe cover limiting bodies disposed on an inner surface of the hollow body;
wherein, when the plurality of ear thermometer probe covers are stacked in sequence and accommodated in the hollow body of the probe cover accommodating portion, the plurality of probe cover limiting bodies are configured to contact a bottommost one of the plurality of ear thermometer probe covers;
wherein the hollow body of the probe cover accommodating portion has a first opening corresponding to the first pushing portion, and a second opening corresponding to the second pushing portion;
wherein a shortest distance between the first opening and the second opening of the hollow body is smaller than a shortest distance between the first pushing portion and the second pushing portion of the probe cover pushing assembly, thereby avoiding interference between the probe cover accommodating accessory and the probe cover pushing assembly;
wherein the probe cover accommodating portion of the probe cover accommodating accessory has a hand-pressed protruding rod portion connected to an outer surface of the hollow body, and the hollow body of the probe cover accommodating portion has a probe cover viewing window facing away from the hand-pressed protruding rod portion; and
wherein the base body of the probe cover delivery base has a first probe cover delivery platform, and a vertical distance between the probe cover limiting body and the first probe cover delivery platform is greater than a height of the ear thermometer probe cover.

4. The probe cover delivery device according to claim 1,
wherein the first supporting portion of the first probe cover pushing element has a first fixed hook body, the first cooperating portion of the probe cover accommodating accessory has a first movable hook body, and a first elastic element is connected between the first fixed hook body of the first supporting portion and the first movable hook body of the probe cover accommodating accessory, thereby adjusting the first cooperating portion of the probe cover accommodating accessory relative to the first supporting portion of the first probe cover pushing element;
wherein the second supporting portion of the second probe cover pushing element has a second fixed hook body, the second cooperating portion of the probe cover accommodating accessory has a second movable hook body, and a second elastic element is connected between the second fixed hook body of the second supporting portion and the second movable hook body of the probe cover accommodating accessory, thereby adjusting the second cooperating portion of the probe cover accommodating accessory relative to the second supporting portion of the second probe cover pushing element;
wherein the base body of the probe cover delivery base has a probe cover accommodating space located between the first sliding groove structure and the second sliding groove structure, and the probe cover accommodating space passes through the base body;
wherein the base body of the probe cover delivery base has a first probe cover delivery platform, a second probe cover delivery platform corresponding to the first probe cover delivery platform, and a probe cover limiting platform connected to the first probe cover delivery platform and the second probe cover delivery platform, and a height of the probe cover limiting platform is lower than a height of the first probe cover delivery platform and a height of the second probe cover delivery platform;
wherein, when a bottommost one of the plurality of ear thermometer probe covers is pushed by the first pushing portion and the second pushing portion of the probe cover pushing assembly to fall from the probe cover accommodating portion of the probe cover accommodating accessory to the base body of the probe cover delivery base, the probe cover accommodating space of the base body of the probe cover delivery base is configured for accommodating a probe cover portion of the fallen ear thermometer probe cover, and the first probe cover delivery platform and the second probe cover delivery platform of the base body of the probe cover delivery base are configured to respectively carry two opposite side portions of the fallen ear thermometer probe cover; and
wherein, when the first probe cover delivery platform and the second probe cover delivery platform of the base body of the probe cover delivery base are configured to respectively carry the two opposite side portions of the fallen ear thermometer probe cover, the fallen ear thermometer probe cover is pushed by the probe cover accommodating accessory to move from the first probe cover delivery platform and the second probe cover delivery platform to the probe cover limiting platform.

5. A probe cover delivery device, comprising:
a probe cover delivery base having a base body;
a probe cover pushing assembly disposed on the base body; and
a probe cover accommodating accessory disposed on the base body;
wherein the probe cover pushing assembly includes a first probe cover pushing element and a second probe cover pushing element corresponding to the first probe cover pushing element, the first probe cover pushing element has a first supporting portion disposed on the base body and a first pushing portion disposed on the first supporting portion, and the second probe cover pushing element has a second supporting portion disposed on the base body and a second pushing portion disposed on the first supporting portion; and
wherein the probe cover accommodating accessory includes a probe cover accommodating portion for accommodating a plurality of ear thermometer probe covers, a first cooperating portion connected to the probe cover accommodating portion, and a second cooperating portion connected to the probe cover accommodating portion.

6. The probe cover delivery device according to claim 5,
wherein the base body of the probe cover delivery base has a probe cover accommodating space, and the probe cover accommodating space passes through the base body;
wherein the base body of the probe cover delivery base has a first probe cover delivery platform, a second probe cover delivery platform corresponding to the first probe cover delivery platform, and a probe cover limiting platform connected to the first probe cover delivery platform and the second probe cover delivery platform, and a height of the probe cover limiting platform is lower than a height of the first probe cover delivery platform and a height of the second probe cover delivery platform;
wherein the first probe cover pushing element and the second probe cover pushing element of the probe cover pushing assembly are detachably disposed on the base body of the probe cover delivery base, and the first probe cover pushing element and the second probe cover pushing element are two independent components or are combined into a single component;
wherein the first pushing portion of the first probe cover pushing element has a first inclined surface, the second pushing portion of the second probe cover pushing element has a second inclined surface, and the first inclined surface of the first pushing portion and the second inclined surface of the second pushing portion are configured to respectively contact two opposite side portions of one of the plurality of ear thermometer probe covers;
wherein a first accommodation space and a second accommodation space are formed between the first supporting portion of the first probe cover pushing element and the second supporting portion of the second probe cover pushing element, the first accommodation space and the second accommodation space are communicated with each other, and a width of the second accommodation space is smaller than a width of the first accommodation space; and
wherein a third accommodation space is formed between the first pushing portion of the first probe cover pushing element and the second pushing portion of the second probe cover pushing element, the third accommodation space is communicated with the second accommodation space, and a width of the third accommodation space is smaller than the width of the second accommodation space.

7. The probe cover delivery device according to claim 5,
wherein the probe cover accommodating portion of the probe cover accommodating accessory has a hollow body and a plurality of probe cover limiting bodies disposed on an inner surface of the hollow body;
wherein, when the plurality of ear thermometer probe covers are stacked in sequence and accommodated in the hollow body of the probe cover accommodating portion, the plurality of probe cover limiting bodies are configured to contact a bottommost one of the plurality of ear thermometer probe covers;
wherein the hollow body of the probe cover accommodating portion has a first opening corresponding to the first pushing portion, and a second opening corresponding to the second pushing portion;
wherein a shortest distance between the first opening and the second opening of the hollow body is smaller than a shortest distance between the first pushing portion and the second pushing portion of the probe cover pushing assembly, thereby avoiding interference between the probe cover accommodating accessory and the probe cover pushing assembly;
wherein the probe cover accommodating portion of the probe cover accommodating accessory has a hand-pressed protruding rod portion connected to an outer surface of the hollow body, and the hollow body of the probe cover accommodating portion has a probe cover viewing window facing away from the hand-pressed protruding rod portion; and
wherein the base body of the probe cover delivery base has a first probe cover delivery platform, and a vertical distance between the probe cover limiting body and the first probe cover delivery platform is greater than a height of the ear thermometer probe cover.

8. The probe cover delivery device according to claim 5,
wherein the first supporting portion of the first probe cover pushing element has a first fixed hook body, the first cooperating portion of the probe cover accommodating accessory has a first movable hook body, and a first elastic element is connected between the first fixed hook body of the first supporting portion and the first movable hook body of the probe cover accommodating accessory, thereby adjusting the first cooperating portion of the probe cover accommodating accessory relative to the first supporting portion of the first probe cover pushing element;
wherein the second supporting portion of the second probe cover pushing element has a second fixed hook body, the second cooperating portion of the probe cover accommodating accessory has a second movable hook body, and a second elastic element is connected between the second fixed hook body of the second supporting portion and the second movable hook body of the probe cover accommodating accessory, thereby adjusting the second cooperating portion of the probe cover accommodating accessory relative to the second supporting portion of the second probe cover pushing element;
wherein the base body of the probe cover delivery base has a probe cover accommodating space, and the probe cover accommodating space passes through the base body;
wherein the base body of the probe cover delivery base has a first probe cover delivery platform, a second probe cover delivery platform corresponding to the first probe cover delivery platform, and a probe cover limiting platform connected to the first probe cover delivery platform and the second probe cover delivery platform, and a height of the probe cover limiting platform is lower than a height of the first probe cover delivery platform and a height of the second probe cover delivery platform;
wherein, when a bottommost one of the plurality of ear thermometer probe covers is pushed by the first pushing portion and the second pushing portion of the probe cover pushing assembly to fall from the probe cover accommodating portion of the probe cover accommodating accessory to the base body of the probe cover delivery base, the probe cover accommodating space of the base body of the probe cover delivery base is configured for accommodating a probe cover portion of the fallen ear thermometer probe cover, and the first probe cover delivery platform and the second probe cover delivery platform of the base body of the probe cover delivery base are configured to respectively carry two opposite side portions of the fallen ear thermometer probe cover; and
wherein, when the first probe cover delivery platform and the second probe cover delivery platform of the base body of the probe cover delivery base are configured to respectively carry the two opposite side portions of the fallen ear thermometer probe cover, the fallen ear thermometer probe cover is pushed by the probe cover accommodating accessory to move from the first probe cover delivery platform and the second probe cover delivery platform to the probe cover limiting platform.

9. A probe cover delivery device, comprising:
a probe cover delivery base;
a probe cover pushing assembly disposed on the probe cover delivery base; and
a probe cover accommodating accessory disposed on the probe cover delivery base;
wherein the probe cover pushing assembly includes a first probe cover pushing element and a second probe cover pushing element, the first probe cover pushing element has a first supporting portion and a first pushing portion disposed on the first supporting portion, and the second probe cover pushing element has a second supporting portion and a second pushing portion disposed on the first supporting portion.

10. The probe cover delivery device according to claim 9,
wherein the probe cover delivery base has a base body, the base body of the probe cover delivery base has a probe cover accommodating space, and the probe cover accommodating space passes through the base body;
wherein the base body of the probe cover delivery base has a first probe cover delivery platform, a second probe cover delivery platform corresponding to the first probe cover delivery platform, and a probe cover limiting platform connected to the first probe cover delivery platform and the second probe cover delivery platform, and a height of the probe cover limiting platform is lower than a height of the first probe cover delivery platform and a height of the second probe cover delivery platform;
wherein the first probe cover pushing element and the second probe cover pushing element of the probe cover pushing assembly are detachably disposed on the base body of the probe cover delivery base, and the first probe cover pushing element and the second probe cover pushing element are two independent components or are combined into a single component;
wherein the first pushing portion of the first probe cover pushing element has a first inclined surface, the second pushing portion of the second probe cover pushing element has a second inclined surface, and the first inclined surface of the first pushing portion and the second inclined surface of the second pushing portion are configured to respectively contact two opposite side portions of one of a plurality of ear thermometer probe covers;
wherein a first accommodation space and a second accommodation space are formed between the first supporting portion of the first probe cover pushing element and the second supporting portion of the second probe cover pushing element, the first accommodation space and the second accommodation space are communicated with each other, and a width of the second accommodation space is smaller than a width of the first accommodation space;
wherein a third accommodation space is formed between the first pushing portion of the first probe cover pushing element and the second pushing portion of the second probe cover pushing element, the third accommodation space is communicated with the second accommodation space, and a width of the third accommodation space is smaller than the width of the second accommodation space;
wherein the probe cover accommodating accessory includes a probe cover accommodating portion for accommodating the plurality of ear thermometer probe covers, the probe cover accommodating portion of the probe cover accommodating accessory has a hollow body and a plurality of probe cover limiting bodies disposed on an inner surface of the hollow body;
wherein, when the plurality of ear thermometer probe covers are stacked in sequence and accommodated in the hollow body of the probe cover accommodating portion, the plurality of probe cover limiting bodies are configured to contact a bottommost one of the plurality of ear thermometer probe covers;
wherein the hollow body of the probe cover accommodating portion has a first opening corresponding to the first pushing portion, and a second opening corresponding to the second pushing portion;
wherein a shortest distance between the first opening and the second opening of the hollow body is smaller than a shortest distance between the first pushing portion and the second pushing portion of the probe cover pushing assembly, thereby avoiding interference between the probe cover accommodating accessory and the probe cover pushing assembly;
wherein the probe cover accommodating portion of the probe cover accommodating accessory has a hand-pressed protruding rod portion connected to an outer surface of the hollow body, and the hollow body of the probe cover accommodating portion has a probe cover viewing window facing away from the hand-pressed protruding rod portion;
wherein the probe cover accommodating accessory includes a first cooperating portion connected to the probe cover accommodating portion, and a second cooperating portion connected to the probe cover accommodating portion;
wherein the first supporting portion of the first probe cover pushing element has a first fixed hook body, the first cooperating portion of the probe cover accommodating accessory has a first movable hook body, and a first elastic element is connected between the first fixed hook body of the first supporting portion and the first movable hook body of the probe cover accommodating accessory, thereby adjusting the first cooperating portion of the probe cover accommodating accessory relative to the first supporting portion of the first probe cover pushing element;
wherein the second supporting portion of the second probe cover pushing element has a second fixed hook body, the second cooperating portion of the probe cover accommodating accessory has a second movable hook body, and a second elastic element is connected between the second fixed hook body of the second supporting portion and the second movable hook body of the probe cover accommodating accessory, thereby adjusting the second cooperating portion of the probe cover accommodating accessory relative to the second supporting portion of the second probe cover pushing element;
wherein, when a bottommost one of the plurality of ear thermometer probe covers is pushed by the first pushing portion and the second pushing portion of the probe cover pushing assembly to fall from the probe cover accommodating portion of the probe cover accommodating accessory to the base body of the probe cover delivery base, the probe cover accommodating space of the base body of the probe cover delivery base is configured for accommodating a probe cover portion of the fallen ear thermometer probe cover, and the first probe cover delivery platform and the second probe cover delivery platform of the base body of the probe cover delivery base are configured to respectively carry two opposite side portions of the fallen ear thermometer probe cover; and
wherein, when the first probe cover delivery platform and the second probe cover delivery platform of the base body of the probe cover delivery base are configured to respectively carry the two opposite side portions of the fallen ear thermometer probe cover, the fallen ear thermometer probe cover is pushed by the probe cover accommodating accessory to move from the first probe cover delivery platform and the second probe cover delivery platform to the probe cover limiting platform;
wherein a vertical distance between the probe cover limiting body and the first probe cover delivery platform is greater than a height of the ear thermometer probe cover.
